(19) United States
(12) Patent Application Publication
(10) Pub. No.: US 2026/0021461 A1
(43) Pub. Date: Jan. 22, 2026

(54) SHAKING DEVICE

(71) Applicant: InnoLux Corporation, Miao-Li County (TW)

(72) Inventors: Huang-Ren YAO, Miao-Li County (TW); Shao-Yu CHIU, Miao-Li County (TW); Jie-Yu YANG, Miao-Li County (TW); Wan-Ling LIN, Miao-Li County (TW)

(21) Appl. No.: 19/244,170

(22) Filed: Jun. 20, 2025

Related U.S. Application Data
(60) Provisional application No. 63/673,358, filed on Jul. 19, 2024.

(30) Foreign Application Priority Data
Mar. 21, 2025 (CN) 202510340181.0

(51) Int. Cl. B01F 31/20; B01F 35/32; B01F 35/42; B01F 101/22

(52) U.S. Cl. CPC B01F 31/201; B01F 35/32; B01F 35/42; B01F 2101/22

(57) ABSTRACT

A shaking device is used for placing a container assembly, and includes: at least one engagement unit including: a body; and a latching element disposed on the body, wherein the at least one engagement unit engages with the container assembly through the latching element; a spindle, wherein the at least one engagement unit is fixed on the spindle; and a driving element coupled with the spindle, wherein the driving element drives the spindle to drive the at least one engagement unit to rotate or swing.

### CROSS-REFERENCE TO RELATED APPLICATIONS

This application claims the benefits of the Chinese Patent Application Serial Number 202510340181.0, filed on Mar. 21, 2025, the subject matter of which is incorporated herein by reference.

This application claims the benefit of filing date of U.S. Provisional Application Ser. No. 63/673,358, filed on Jul. 19, 2024 under 35 USC § 119(e)(1).

### BACKGROUND

### Field

The present disclosure provides a shaking device. More particularly, the present disclosure provides a shaking device used for placing a container assembly.

### Description of Related Art

Traditionally, when preparing drugs, medical staff have to manually dissolve the solutes. However, it takes a lot of time to dissolve solutes that are difficult to dissolve, which increases the burden on medical staff. If the dissolution time is not sufficient and the solute is not completely dissolved, the concentration of the solution will be insufficient or uneven, which will affect the medical effect.

Therefore, it is desirable to provide a shaking device to improve the conventional defects.

### SUMMARY

The present disclosure provides a shaking device used for placing a container assembly and comprising: at least one engagement unit comprising: a body; and a latching element disposed on the body, wherein the at least one engagement unit engages with the container assembly through the latching element; a spindle, wherein the at least one engagement unit is fixed on the spindle; and a driving element coupled with the spindle, wherein the driving element drives the spindle to drive the at least one engagement unit to rotate or swing.

Other novel features of the disclosure will become more apparent from the following detailed description when taken in conjunction with the accompanying drawings.

### BRIEF DESCRIPTION OF DRAWINGS

FIG. 1 is a block diagram of a drug preparing process according to one embodiment of the present disclosure.

FIG. 2A is a schematic three-dimensional diagram of a shaking device according to one embodiment of the present disclosure.

FIG. 2B is an exploded view of the shaking device of FIG. 2A.

FIG. 3 is a schematic diagram of a container assembly according to one embodiment of the present disclosure.

FIG. 4 is a schematic diagram of the operation of a shaking device according to one embodiment of the present disclosure.

FIG. 5 is a block diagram of the operation flow of a shaking device according to one embodiment of the present disclosure.

FIG. 6A and FIG. 6B are schematic three-dimensional diagrams of a shaking device according to one embodiment of the present disclosure.

FIG. 6C is a partially enlarged view of the shaking device of FIG. 6A.

FIG. 6D is an exploded view of the shaking device of FIG. 6C.

FIG. 7A and FIG. 7B are cross-sectional views of a portion of a shaking device according to one embodiment of the present disclosure.

FIG. 7C is a partially enlarged view of FIG. 7B.

FIG. 7D is a cross-sectional schematic view of a portion of a shaking device according to one embodiment of the present disclosure.

FIG. 7E is a partially enlarged view of FIG. 7D.

FIG. 8 is a schematic diagram of the operation of a shaking device according to one embodiment of the present disclosure.

FIG. 9A and FIG. 9B are schematic three-dimensional diagrams of a shaking device according to one embodiment of the present disclosure.

FIG. 10A and FIG. 10B are schematic three-dimensional diagrams of a shaking device according to one embodiment of the present disclosure.

### DETAILED DESCRIPTION

The following is a detailed description of the electronic device according to the embodiment of the present disclosure. It should be understood that the following description provides many different embodiments for implementing different aspects of some embodiments of the present disclosure. Specific examples of each component and its configuration are described below to simplify the embodiments of the present disclosure. Of course, these are only examples and are not intended to limit the present disclosure. In addition, similar and/or corresponding reference numerals may be used to identify similar and/or corresponding elements in different embodiments to clearly describe the present disclosure. However, the use of these similar and/or corresponding reference numerals is only for the purpose of simply and clearly describing some embodiments of the present disclosure, and does not imply any correlation between the different embodiments and/or structures discussed.

The embodiments of the present disclosure may be understood in conjunction with the drawings, which are also considered part of the disclosure. It should be understood that the drawings of the present disclosure are not drawn to scale, and in fact, the size of the elements may be arbitrarily enlarged or reduced in order to clearly show the features of the present disclosure. In addition, the directional terms mentioned in the present disclosure, such as “up”, “down”, “front”, “back”, “left”, “right”, etc., are only referenced to the directions of the accompanying drawings. Therefore, the directional terms used are for illustration and are not intended to limit the present disclosure. In the accompanying drawings, each diagram depicts the general characteristics of the methods, structures and/or materials used in a particular embodiment. However, these diagrams should not be interpreted as defining or limiting the scope or nature covered by these embodiments. For example, for the sake of clarity, the relative size, thickness and position of each layer, region and/or structure may be reduced or enlarged.

One structure (or layer, component, or substrate) described in the present disclosure is located on/above another structure (or layer, component, or substrate). This may mean that the two structures are adjacent and directly connected, or the two structures are adjacent rather than directly connected. Indirect connection means that there is at least one intermediary structure (or intermediary layer, intermediary component, intermediary substrate, or intermediary spacer) between two structures. The lower surface of one structure is adjacent to or directly connected to the upper surface of the intermediary structure, and the upper surface of another structure is adjacent to or directly connected to the lower surface of the intermediary structure. The intermediary structure can be composed of a single-layer or multi-layer solid structure or a non-solid structure, and there is no limit. In the present disclosure, when a structure is disposed “on” another structure, it may mean that the structure is “directly” on the other structure, or that the structure is “indirectly” on the other structure, that is, at least one structure is also sandwiched between the structure and the other structure. In the present disclosure, the term “relatively disposed” or “disposed relative to . . . ” refers to, for example, that the elements substantially overlap with each other, but the present disclosure is not limited thereto.

In addition, it should be understood that the ordinal numbers used in the description and the claims, such as “first”, “second”, etc., are intended only to describe the elements claimed and imply or represent neither that the (these) elements have any proceeding ordinals, nor that sequence between one claimed element and another claimed element or between steps of a manufacturing method. The use of these ordinals is merely to differentiate one claimed element having a certain designation from another claimed element having the same designation. The same words may not be used in the claim and the description. For example, the first element in the description may be the second element in the claim.

In some embodiments of the present disclosure, terms related to joining and connecting, such as “connection”, “interconnection”, etc., unless otherwise defined, may mean that two structures are in direct contact, or may also mean that two structures are not in direct contact where other structures are located between these two structures. The terms “joint” and “connection” can also include situations where both structures are movable, or where both structures are fixed. In addition, the terms “coupling” include any direct and indirect means of connection.

In the present specification, the terms, such as “about”, “substantially”, or “approximately”, are generally interpreted as within 10%, 5%, 3%, 2%, 1%, or 0.5% of a given value or range. Unless otherwise stated, when a value is “in a range from a first value to a second value” or “in a range between a first value and a second value”, the value can be the first value, the second value, or another value between the first value and the second value. In addition, any two values or directions used for comparison may have certain errors. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°. In the present disclosure, the term “the given range is from the first value to the second value” and “the given range falls within the range of the first value to the second value” mean that the given range includes the first value, the second value and another value between the first value and the second value.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

In addition, the shaking device disclosed in the present application can be applied to the electronic device itself or the application of the electronic device. The electronic device may include, but is not limited to, automated equipment, clamping devices, mobile platform picking devices, computing devices, mechanical equipment, drug preparation devices, exposure devices, printing devices, three-dimensional printing devices, automotive devices, imaging devices, assembly devices, backlight devices, antenna devices, tiled devices, touch electronic devices, curved electronic devices, or free shape electronic devices. The display device may include, for example, liquid crystals, light emitting diodes, fluorescence, phosphors, other suitable display media, or a combination thereof, but the present disclosure is not limited thereto. The display device may be a non-self-luminous display device or a self-luminous display device. The antenna device may be a liquid crystal antenna device or a non-liquid crystal antenna device. The sensing device may be a sensing device that can sense capacitance, light, heat energy or ultrasonic waves. But, the present disclosure is not limited thereto. The tiled device may be, for example, a tiled display device or a tiled antenna device, but is not limited thereto. It should be noted that the electronic device may be any permutation and combination of the above, but is not limited thereto. The electronic device may be a bendable or flexible electronic device. It should be noted that the electronic device may be any permutation and combination of the above, but not limited to this. In addition, the shape of the electronic device may be rectangular, circular, polygonal, or having a shape with curved edges or other suitable shapes. The electronic device may have peripheral systems such as drive systems, control systems, light source systems, shelf systems, etc. to support the display device, the antenna device or the tiled device. The electronic device may include, for example, electronic components, liquid crystals, light emitting diodes, quantum dots (QDs), fluorescence, phosphors, other suitable display media, or a combination of the above materials, but is not limited thereto. Electronic components may include passive components and active components, such as capacitors, resistors, inductors, diodes, transistors, etc. The diode may include a light emitting diode or a photodiode. The light emitting diode may comprise, for example, an organic light emitting diode (OLED), a mini LED, a micro LED or a quantum dot LED which may include a QLED or a QDLED, a light emitting diode of a flexible display, other suitable material or a combination thereof, but the present disclosure is not limited thereto.

It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the invention or conflict with each other.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those known in the art, the background of the present disclosure or the context of the present specification, and should not be read by an ideal or over-formal way.

It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the invention or conflict with each other. It should be noted that the technical solutions provided in the following different embodiments can be replaced, combined or mixed with each other to form another embodiment without violating the spirit of the present disclosure.

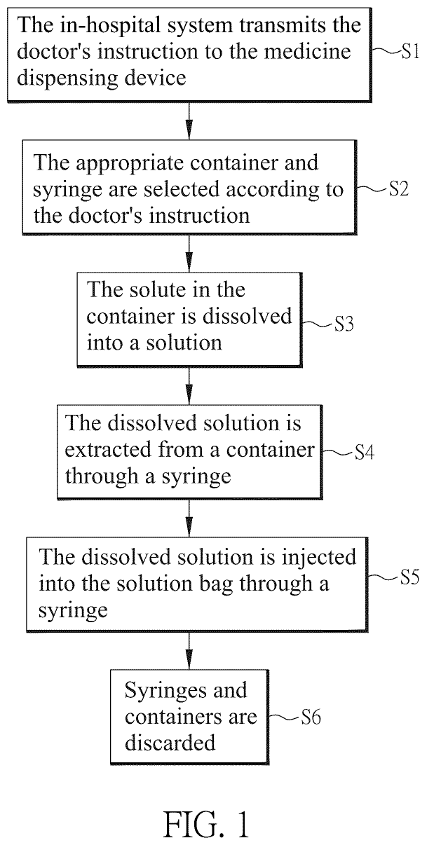

FIG. 1 is a block diagram of a drug preparing process according to one embodiment of the present disclosure.

In one embodiment of the present disclosure, as shown in FIG. 1, the drug preparing process may comprise the following steps. The Step S1 is performed, in which the in-hospital system transmits the doctor's instruction (such as medicine orders) to the medicine dispensing device. The Step S2 is then performed, in which the operator of the medicine dispensing device or the medicine dispensing device itself (if the medicine dispensing device has an automated function) selects the appropriate container and syringe according to the doctor's instruction. The Step S3 is performed, in which the solute in the container is dissolved into a solution. In the present disclosure, the solute may include powders of drugs, nutritional supplements and/or other ingredients, which are dissolved to form a solution containing the above ingredients. The drugs include, for example, chemotherapy drugs, analgesics, other drugs suitable for intravenous injection, or a combination thereof, but the present disclosure is not limited thereto. The nutritional supplements include, for example, sugar, vitamins, potassium ions, other suitable nutritional additives, or a combination thereof, but the present disclosure is not limited thereto.

The Step S4 is performed, in which the medicine dispensing device extracts the dissolved solution from a container through a syringe. Then, the Step S5 is performed, in which the medicine dispensing device injects the dissolved solution into the solution bag through a syringe. Finally, the Step S6 is performed, in which the medicine dispensing device discards syringes and containers to complete the drug preparation. When performing the Step S3, the shaking device of the present disclosure can be introduced to realize an automated drug preparation process, thereby improving the dissolution efficiency of the solute and/or reducing the burden on medical staff.

The shaking device of the present invention will be described in detail below.

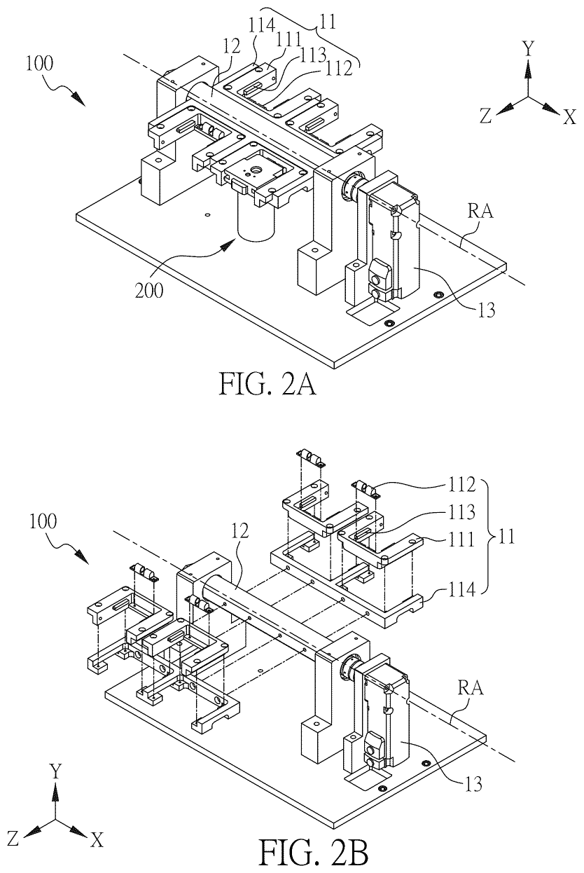

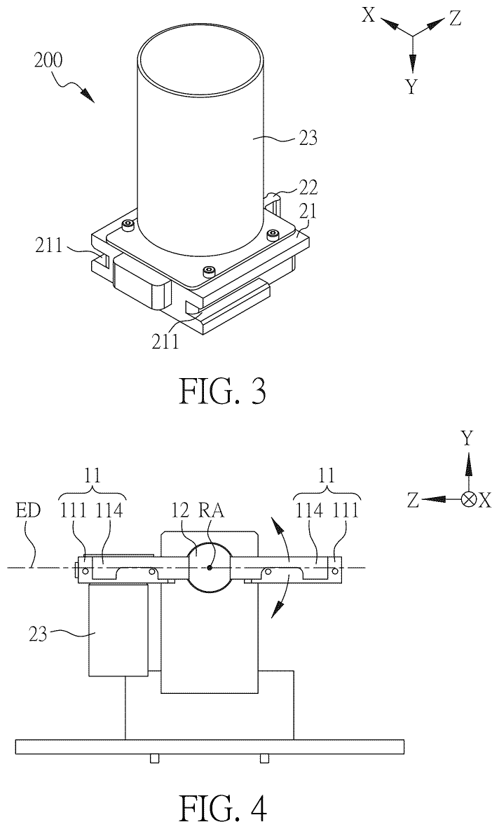

FIG. 2A is a schematic three-dimensional diagram of a shaking device according to one embodiment of the present disclosure. FIG. 2B is an exploded view of the shaking device of FIG. 2A. FIG. 3 is a schematic diagram of a container assembly according to one embodiment of the present disclosure. FIG. 4 is a schematic diagram of the operation of a shaking device according to one embodiment of the present disclosure.

In one embodiment of the present disclosure, as shown in FIG. 2A and FIG. 2B, the shaking device 100 may be used for placing a container assembly 200, and the shaking device 100 may comprise at least one engagement unit 11; a spindle 12, wherein the at least one engagement unit 11 is fixed on the spindle 12; and a driving element 13 coupled with the spindle 12, wherein the driving element 13 drives the spindle 12 to drive the at least one engagement unit 11 to rotate or swing. More specifically, the at least one engagement unit 11 may comprise: a body 111; and a latching element 112 disposed on the body 111, wherein the latching element 112 and the container assembly 200 may engage with each other to fix the container assembly 200 on the engagement unit 11. In the present disclosure, as shown in FIG. 2A and FIG. 2B, the shaking device 100 is exemplified by including four engagement units 11, but the present disclosure is not limited thereto. In other aspects, the number and location of the engagement units 11 may be adjusted as needed.

In one embodiment of the present disclosure, as shown in FIG. 2A and FIG. 3, the container assembly 200 may comprise: a base 21; a fastening part 22 disposed on the base 21, wherein the engagement unit 11 may engage with the fastening part 22 of the container assembly 200 through the latching element 112, so the shaking device 100 can clamp the container assembly 200 and restrict the movement of the container assembly 200 in the X direction and the Z direction; and a container 23 fixed on the base 21, wherein the container 23 may contain the solute to be dissolved before the container assembly 200 is operated by the shaking device 100. In one embodiment of the present disclosure, as shown in FIG. 3, the base 21 of the container assembly 200 may further comprise a groove 211, which may be used to assist the shaking device 100 in clamping the container assembly 200 and/or provide a robot arm (not shown) to clamp the container assembly 200.

In one embodiment of the present disclosure, as shown in FIG. 2A and FIG. 2B, the engagement unit 11 may further comprise a protruding part 113 disposed on the body 111, wherein the protruding part 113 and the container assembly 200 interfere with each other when the container assembly 200 is placed on the shaking device 100. More specifically, when the container assembly 200 is placed on the shaking device 100, the protruding part 113 of the engagement unit 11 may interfere with the groove 211 of the container assembly 200 to improve the reliability of the shaking device 100 clamping the container assembly 200. For example, a rough surface or a protrusion (not shown) may be formed on the protruding part 113 to reduce the probability of the container assembly 200 being separated from the engagement unit 11 when the shaking device 100 is in operation. In the present disclosure, as shown in FIG. 2A, each engagement unit 11 is exemplified by two protruding parts 113 disposed on opposite sides, but the present disclosure is not limited thereto. In other aspects, the number and location of the protruding part 113 can be adjusted as needed.

In one embodiment of the present disclosure, as shown in FIG. 2A and FIG. 2B, the engagement unit 11 may further comprise a locking unit 114, and the engagement unit 11 is fixed on the spindle 12 through the locking unit 114. When the spindle 12 rotates, it can drive at least one engagement unit 11 to rotate along a rotation axis RA, wherein the rotation axis RA may be parallel to a horizontal plane (for example, the XZ plane). In one embodiment of the present disclosure, as shown in FIG. 2A and FIG. 2B, the rotation axis RA may be, for example, parallel to an extension direction of the spindle 12 (for example, may be parallel to the X direction), but the present disclosure is not limited thereto. In the present disclosure, the “rotation axis RA” refers to, for example, a virtual line around which the spindle 12 rotates.

In one embodiment of the present disclosure, as shown in FIG. 4, when viewed from the spindle 12 toward the driving element 13 (as shown in FIG. 2A), when the driving element 13 (as shown in FIG. 2A) drives the spindle 12, at least one engagement unit 11 may rotate by a first angle in a first motion A1 and rotate by a second angle in a second motion A2 following the first motion A1. The first motion A1 is, for example, a clockwise rotation of 10 to 30 degrees along the rotation axis RA (that is, 10°≤the first angle≤30°), and the second motion A2 is, for example, a counterclockwise rotation of 0 to 60 degrees along the rotation axis RA (that is, 0°≤the second angle≤60°), but the present disclosure is not limited thereto. In other aspects, the first motion A1 may be, for example, a counterclockwise rotation of 10 to 30 degrees along the rotation axis RA (that is, 10°≤the first angle≤30°), and the second motion A2 may be, for example, a clockwise rotation of 0 to 60 degrees along the rotation axis RA (that is, 0°≤the second angle≤60°). Thus, in one embodiment of the present disclosure, the rotation direction of the first motion A1 may be different from the rotation direction of the second motion A2. When the rotation angles of the first motion A1 and the second motion A2 meets the aforesaid definitions, the dissolution efficiency of the solute in the container 23 may be improved and/or the risk of the container assembly 200 being separated from the shaking device 100 may be reduced. The “angle” is calculated, for example, on the basis that an extension direction ED of the body 111 of the engagement unit 11 parallel to a horizontal plane (for example, the XZ plane) is as 0 degrees in a side view when the engagement unit 11 is in an initial state. Thus, the engagement unit 11 rotating 10 to 30 degrees clockwise along the rotation axis RA refers to that, for example, the extension direction ED of the body 111 rotates clockwise until the included angle between the extension direction ED of the body 111 and a horizontal plane (for example, the XZ plane) is 10 to 30 degrees in the side view.

In one embodiment of the present disclosure, after the second motion A2 is completed, a third motion A3 following the second motion A2 may be further performed. The third motion A3 is to restore the shaking device 100 to the initial position, that is, to restore the extension direction ED of the body 111 to be parallel to the horizontal plane (for example, the XZ plane). In the present disclosure, the shaking device 100 can performed a shaking operation for 4000 to 5000 cycles, and the shaking operation may include the first motion A1, the second motion A2 and the third motion A3 as described above, that is, one cycle of the shaking operation can include the first motion A1, the second motion A2 following the first motion A1 and the third motion A3 following the second motion A2. When the shaking operation meets the above definition, the dissolution efficiency of the solute in the container 23 can be improved, thereby achieving the effect of shortening the dissolution time.

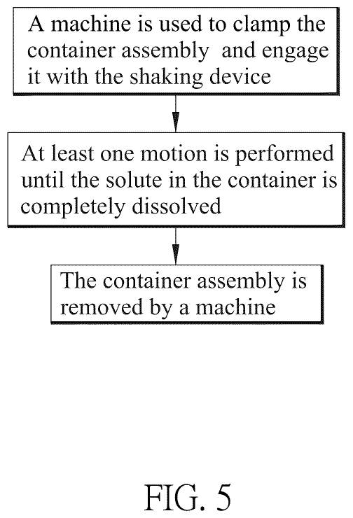

FIG. 5 is a block diagram of the operation flow of a shaking device according to one embodiment of the present disclosure, wherein the shaking device may be, for example, as shown in FIG. 2A to FIG. 2B, and the container assembly may be, for example, as shown in FIG. 3, which will not be described in detail below.

In one embodiment of the present disclosure, as shown in FIG. 2A to FIG. 5, the operation process of the shaking device may include the following steps. First, a machine (such as a robot arm, not shown) is used to clamp the container assembly 200 and engage it with the shaking device 100. At this time, the solute in the container 23 has not yet completely dissolved. Next, at least one motion (for example, the first motion A1, the second motion A2, and the third motion A3) is performed until the solute in the container 23 is completely dissolved. Then, the container assembly 200 is removed by a machine (not shown), thereby achieving an automated operation of dissolving the solute using the shaking device 100.

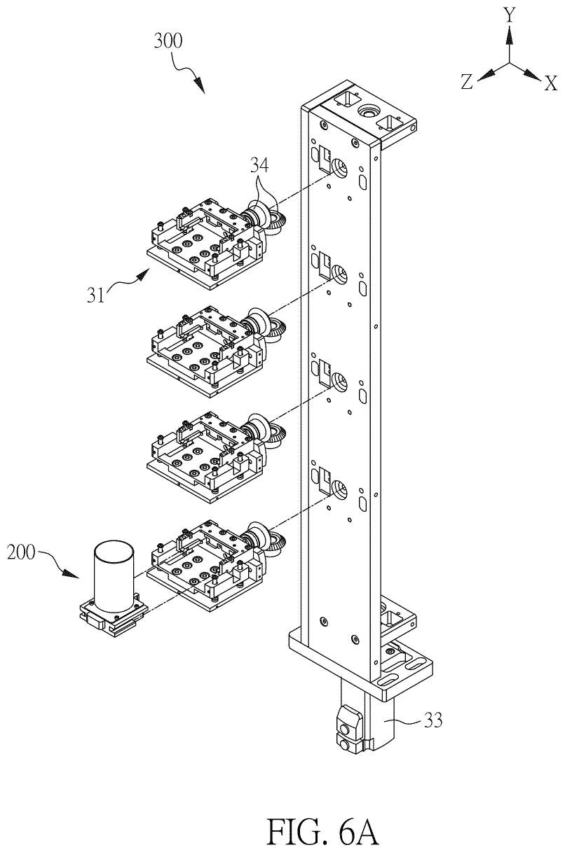

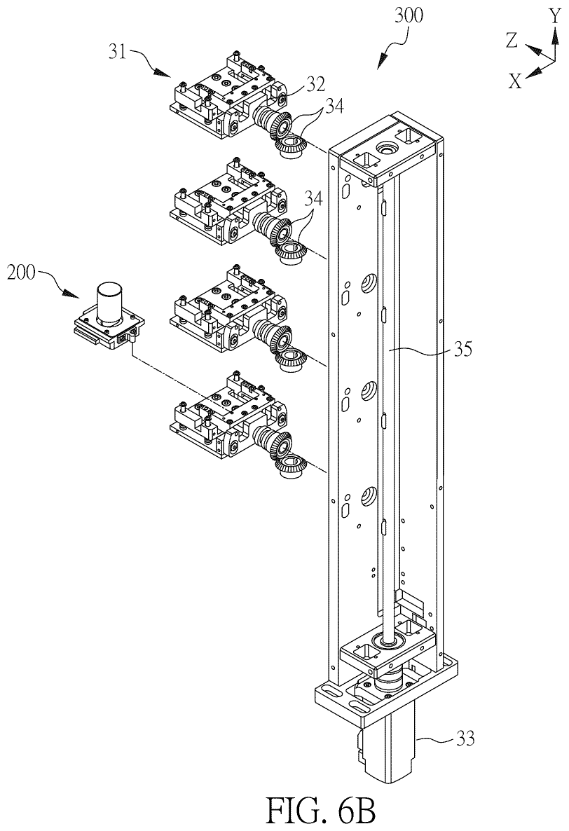

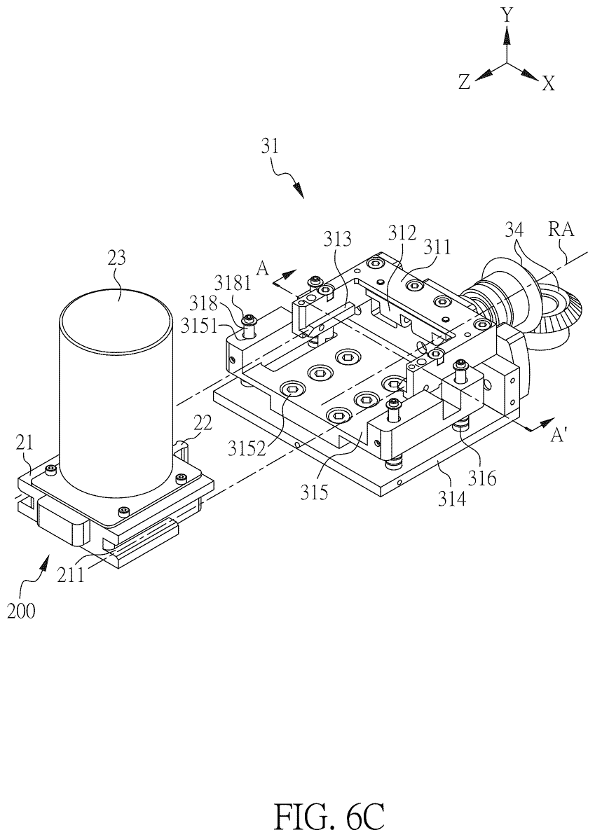

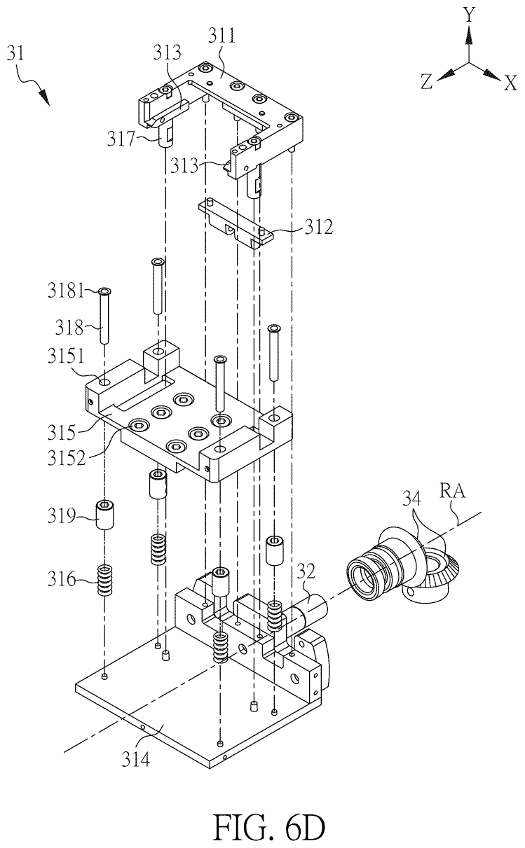

FIG. 6A and FIG. 6B are schematic three-dimensional diagrams of a shaking device according to one embodiment of the present disclosure. FIG. 6C is a partially enlarged view of the shaking device of FIG. 6A. FIG. 6D is an exploded view of the shaking device of FIG. 6C.

In one embodiment of the present disclosure, as shown in FIG. 6A to FIG. 6D, the shaking device 300 may be used for placing a container assembly 200, and the shaking device 300 may comprise at least one engagement unit 31; a spindle 32, wherein the at least one engagement unit 31 is fixed on the spindle 32; and a driving element 33 coupled with the spindle 32, wherein the driving element 33 drives the spindle 32 to drive the at least one engagement unit 31 to rotate or swing.

In one embodiment of the present disclosure, as shown in FIG. 6C and FIG. 6D, the at least one engagement unit 31 may comprise: a body 311; and a latching element 312 disposed on the body 311, wherein the at least one engagement unit 31 and the fastening part 22 of the container assembly 200 engage with each other through the latching element 312. The container assembly 200 may be as shown in FIG. 3, and will not be described in detail herein. In the present disclosure, the shaking device 300 of FIG. 6A and FIG. 6B includes four engagement units 31, and the four engagement units 31 are arranged in a 1×4 array as an example, but the present disclosure is not limited thereto. In other aspects, the number and location of the engagement units 31 may be adjusted as needed.

In one embodiment of the present disclosure, as shown in FIG. 6C and FIG. 6D, the engagement unit 31 may further comprise a protruding part 313 disposed on the body 311, wherein the protruding part 313 and the container assembly 200 interfere with each other when the container assembly 200 is placed on the shaking device 300. More specifically, when the container assembly 200 is placed on the shaking device 300, the protruding part 313 of the engagement unit 31 and the groove 211 of the container assembly 200 may interfere with each other to improve the reliability of the shaking device 300 clamping the container assembly 200. In the present disclosure, as shown in FIG. 6C and FIG. 6D, each engagement unit 31 is exemplified by two protruding parts 313 disposed on opposite sides, but the present disclosure is not limited thereto. In other aspects, the number and location of the protruding part 313 can be adjusted as needed.

In one embodiment of the present disclosure, as shown in FIG. 6A to FIG. 6D, the engagement unit 31 may further comprise: a base plate 314, wherein the body 311 is fixed on the base plate 314; a moving element 315 disposed on the base plate 314; and an elastic element 316 disposed between the base plate 314 and the moving element 315. More specifically, as shown in FIG. 6C and FIG. 6D, the body 311 may be fixed on the base plate 314 through a locking unit 317. The moving element 315 may be slidably connected to a guidepost 318, and the guidepost 318 allows the moving element 315 to move in the extension direction (for example, the +Y direction and/or the −Y direction) of the guidepost 318 through the elastic element 316. More specifically, the moving element 315 may comprise a through hole 3151, the guidepost 318 passes through the through hole 3151 and is fixed on the base plate 314, and one end of the guidepost 318 may comprise a gasket 3181, which may be used to limit the movement of the moving element 315 in the extension direction of the guidepost 318 (for example, the +Y direction). In one embodiment of the present disclosure, as shown in FIG. 6D, the engagement unit 31 may further comprise a bushing 319 which may engage with the through hole 3151 of the moving element 315. In the present disclosure, FIG. 6D shows an example including two locking units 317, but the present disclosure is not limited thereto. In other aspects, the number and location of the locking units 317 can be adjusted as needed. Similarly, FIG. 6D shows an example including four elastic elements 316, four guideposts 318, four bushings 319, and four through holes 3151, but the present disclosure is not limited thereto. In other aspects, the number and location of the elastic elements 316, the guideposts 318, the bushings 319, and the through holes 3151 may be adjusted as needed.

In one embodiment of the present disclosure, as shown in FIG. 6C and FIG. 6D, the moving element 315 may comprise a roller 3152, which may slide with the base 21 of the container assembly 200. That is, when a machine (not shown) clamps the container assembly 200 and engages it with the shaking device 300, the base 21 of the container assembly 200 can slide on the moving element 315 through the roller 3152 and engage with the latching element 312 through the fastening part 22, so as to reduce the contact area between the base 21 of the container assembly 200 and the moving element 315, thereby reducing the friction between the two. In the present disclosure, FIG. 6C and FIG. 6D shows an example including six rollers 3152, but the present disclosure is not limited thereto. In other aspects, the number and location of rollers 3152 can be adjusted as needed.

In one embodiment of the present disclosure, as shown in FIG. 6B to FIG. 6D, one end of the spindle 32 may be connected to the base plate 314 of the engagement unit 31, so that the engagement unit 31 is fixed on the spindle 32. The other end of the spindle 32 may be engaged with a bevel gear set 34. The spindle 32 may be coupled to the driving element 33 through a bevel gear set 34 and a transmission shaft 35. When the driving element 33 drives the transmission shaft 35 to rotate, the bevel gear set 34 is driven to rotate by the transmission shaft 35, and the spindle 32 is driven to rotate through the bevel gear set 34, thereby driving the engagement unit 31 to rotate along a rotation axis RA. Herein, the rotation axis RA may be parallel to a horizontal plane (for example, the XZ plane). In one embodiment of the present disclosure, as shown in FIG. 6B to FIG. 6D, the rotation axis RA may be, for example, parallel to the extension direction of the spindle 32 (for example, may be parallel to the Z direction), but the present disclosure is not limited thereto. In the present disclosure, the “rotation axis RA” refers to, for example, a virtual line around which the spindle 32 rotates. In one embodiment of the present disclosure, the extending direction of the spindle 32 may be different from the extending direction of the transmission shaft 35. In other words, the extending direction of the rotation axis RA may be different from the extending direction of the transmission shaft 35. In one embodiment of the present disclosure, the extending direction of the spindle 32 may be perpendicular to the extending direction of the transmission shaft 35.

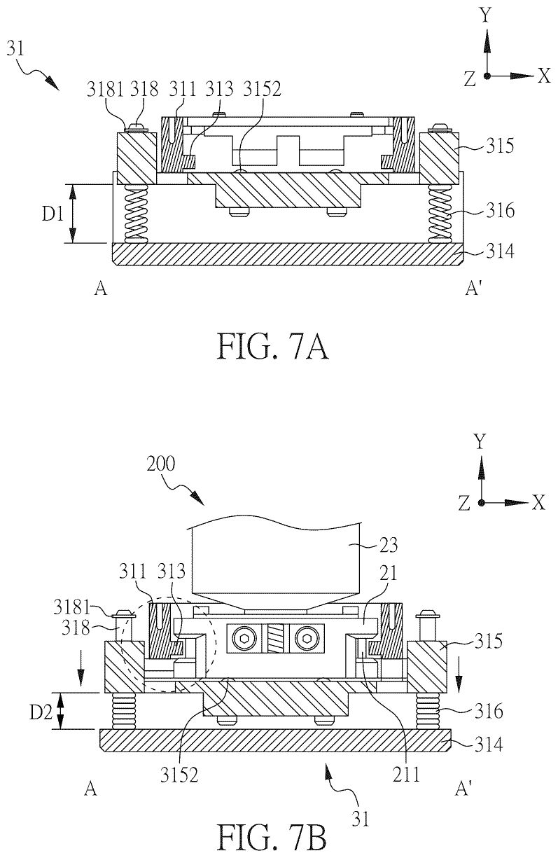

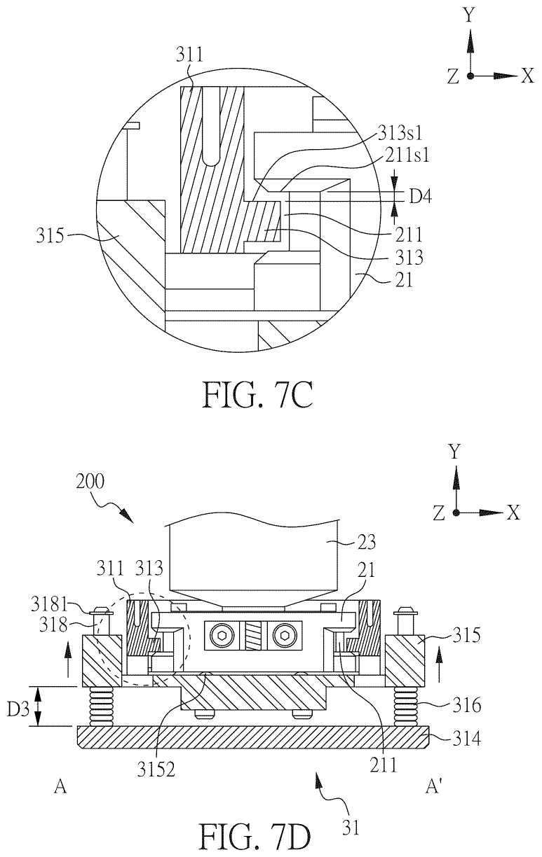

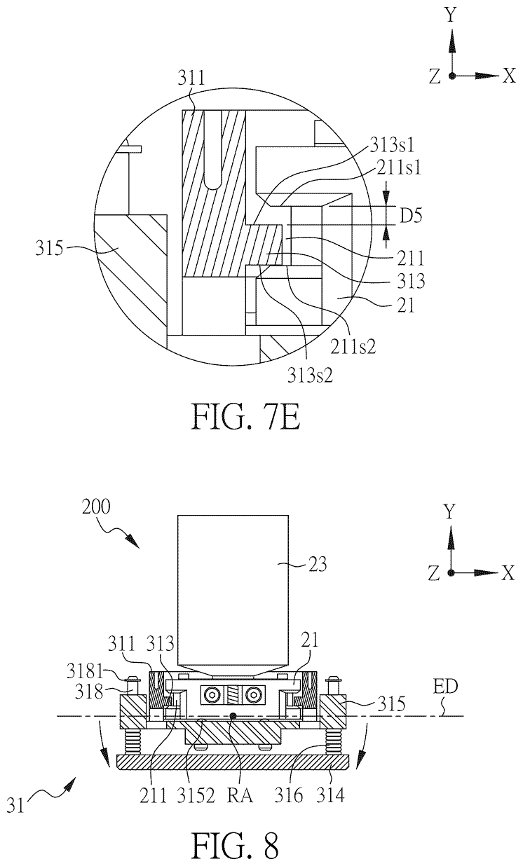

FIG. 7A and FIG. 7B are cross-sectional views of a portion of a shaking device according to one embodiment of the present disclosure. FIG. 7C is a partially enlarged view of FIG. 7B. FIG. 7D is a cross-sectional schematic view of a portion of a shaking device according to one embodiment of the present disclosure. FIG. 7E is a partially enlarged view of FIG. 7D. The shaking device of FIG. 7A to FIG. 7E may be as that shown in FIG. 6A to FIG. 6D, and FIG. 7A, FIG. 7B and FIG. 7D may be cross-sectional views of the line segment A-A′ of FIG. 6C.

In one embodiment of the present disclosure, as shown in FIG. 7A, when the container assembly 200 is not placed on the shaking device 300, the elastic element 316 may have an initial length D1. The container assembly 200 is shown in FIG. 3 and will not be described in detail herein. When a machine (not shown) clamps the container assembly 200 and the base 21 of the container assembly 200 contacts the roller 3152 on the moving element 315, as shown in FIG. 7B, the machine (not shown) may apply force in a direction (for example, the −Y direction), and the elastic element 316 is compressed, causing the moving element 315 to move in the direction (for example, the −Y direction), and the elastic element 316 may have a first length D2. Herein, the first length D2 is less than the initial length D1 (that is, D2<D1). In the present disclosure, the “length of the elastic element” refers, for example, to the maximum length of the elastic element 316 in the normal direction (for example, the Y direction) of the engagement unit 31 in this state. In this state, since the elastic element 316 is compressed and drives the moving element 315 to move in the direction (for example, the −Y direction), as shown in FIG. 7C, there may be a distance D4 between the upper surface 313s1 of the protruding part 313 of the engagement unit 31 and the upper surface 211s1 of the groove 211 of the container assembly 200, and the protruding part 313 of the engagement unit 31 will not contact the upper surface 211s1 of the groove 211 of the container assembly 200 (that is, D4>0).

When the container assembly 200 is placed on the shaking device 300 and the machine (not shown) is removed, as shown in FIG. 7D, the elastic element 316 loses the mechanical force and moves toward another direction (for example, the +Y direction), while driving the moving element 315 to move toward another direction (for example, the +Y direction). At this time, the elastic element 316 may have a second length D3. The second length D3 is less than the initial length D1 and greater than the first length D2 (that is, D2<D3<D1). In this state, since the elastic element 316 loses its mechanical force, it drives the moving element 315 to move toward another direction (for example, the +Y direction). As shown in FIG. 7E, there may be a distance D5 between the upper surface 313s1 of the protruding part 313 of the engagement unit 31 and the upper surface 211s1 of the groove 211 of the container assembly 200, and the lower surface 313s2 of the protruding part 313 of the engagement unit 31 may contact the lower surface 211s2 of the groove 211 of the container assembly 200. In this way, the engagement effect between the engagement unit 31 and the container assembly 200 can be enhanced through the friction force generated by the contact between the lower surface 313s2 of the protruding part 313 and the lower surface 211s2 of the groove 211. In the present disclosure, the distance D5 may be greater than the distance D4 (for example, D5>D4). The “distance” refers, for example, to the maximum distance between the upper surface 313s1 of the protruding part 313 of the engagement unit 31 and the upper surface 211s1 of the groove 211 of the container assembly 200 in the normal direction (for example, the Y direction) of the engagement unit 31 in this state.

FIG. 8 is a schematic diagram of the operation of a shaking device according to one embodiment of the present disclosure, wherein the shaking device may be as shown in FIGS. 6A to 6D, which will not be described in detail herein.

In one embodiment of the present disclosure, as shown in FIG. 6B and FIG. 8, when the driving element 33 drives the spindle 32, the engagement unit 31 can rotate in a single first motion A1. The first motion A1 is, for example, one clockwise rotation along the rotation axis RA (that is, 360° clockwise rotation), but the present disclosure is not limited thereto. In other aspects, the first motion A1 is, for example, one counterclockwise rotation along the rotation axis RA (that is, 360° counterclockwise rotation). In the present disclosure, the shaking device 300 may perform a shaking operation for 1500 to 2500 cycles, and the shaking operation may include the first motion A1 as described above. When the shaking operation meets the above definition, the dissolution efficiency of the solute in the container 23 can be improved, thereby achieving the effect of shortening the dissolution time.

In another embodiment of the present disclosure, as shown in FIG. 6B and FIG. 8, when the driving element 33 drives the spindle 32, the engagement unit 31 can rotate in a first motion A1, a second motion A2 following the first motion A1, a third motion A3 following the second motion A2, and a fourth motion A4 following the third motion A3. The first motion A1 may include a first sub-motion A1-1, a second sub-motion A1-2 following the first sub-motion A1-1, a third sub-motion A1-3 following the second sub-motion A1-2, and a fourth sub-motion A1-4 following the third sub-motion A1-3. The first sub-motion A1-1 is, for example, a clockwise rotation of 150 degrees to 180 degrees along the rotation axis RA (that is, 150°≤the angle≤180°), the second sub-motion A1-2 is, for example, a counterclockwise rotation of 30 degrees to 70 degrees along the rotation axis RA (that is, 30°≤the angle≤70°), the third sub-motion A1-3 is, for example, a counterclockwise rotation of 0 degrees to 60 degrees along the rotation axis RA (that is, 0°≤the angle≤60°), and the fourth sub-motion A1-4 is, for example, a clockwise rotation of 0 degrees to 130 degrees along the rotation axis RA (that is, 0°≤the angle≤130°). The second motion A2 is, for example, a counterclockwise rotation of 300 to 330 degrees along the rotation axis RA (that is, 300°≤the angle≤330°). The third motion A3 may include a first sub-motion A3-1, a second sub-motion A3-2 following the first sub-motion A3-1, and a third sub-motion A3-3 following the second sub-motion A3-2. The first sub-motion A3-1 is, for example, a clockwise rotation of 50 to 70 degrees along the rotation axis RA (that is, 50°≤the angle≤70°), the second sub-motion A3-2 is, for example, a clockwise rotation of 30 to 50 degrees along the rotation axis RA (that is, 30°≤the angle≤50°), and the third sub-motion A3-3 is, for example, a counterclockwise rotation of 90 to 120 degrees along the rotation axis RA (that is, 90°≤the angle≤120°). The fourth motion A4 is, for example, a clockwise rotation of 300 to 330 degrees along the rotation axis RA (that is, 300°≤the angle≤330°). When the rotation angle of the above motion meets the above definition, the dissolution efficiency of the solute in the container 23 can be improved. As shown in FIG. 8, the “angle” is calculated, for example, on the basis that an extension direction ED of the body 111 of the engagement unit 11 parallel to a horizontal plane (for example, the XZ plane) and perpendicular to the rotation axis RA is as 0 degrees in a side view when the engagement unit 11 is in an initial state. Therefore, the engagement unit 31 rotating 150 to 180 degrees clockwise along the rotation axis RA refers to that, for example, in the side view, the extension direction ED of the body 311 is rotated clockwise until the angle between the extension direction ED of the body 311 and a horizontal plane (such as the XZ plane) is 150 to 180 degrees. In one embodiment of the present disclosure, the second sub-motion A1-2 and the third sub-motion A1-3 have the same rotation direction but different rotation angles, and the first sub-motion A3-1 and the second sub-motion A3-2 have the same rotation direction but different rotation angles. In one embodiment of the present disclosure, the shaking device 300 can perform a shaking operation for 300 to 700 cycles, and each shaking operation may include a first motion A1 that is cycled 1 to 5 times, followed by a second motion A2, and then a third motion A3 that is cycled 1 to 5 times, followed by a fourth motion A4, wherein the first motion A1, the second motion A2, the third motion A3 and the fourth motion A4 are each as described above. When the shaking operation meets the above definition, the dissolution efficiency of the solute in the container 23 can be improved, thereby achieving the effect of shortening the dissolution time.

In another embodiment of the present disclosure, as shown in FIG. 6B and FIG. 8, when the driving element 33 drives the spindle 32, the engagement unit 31 may rotate in a fifth motion A5 and a sixth motion A6 following the fifth motion A5. The fifth action A5 is, for example, a clockwise rotation along the rotation axis RA, and the rotation time is 1 to 5 seconds, and the sixth action A6 is, for example, a counterclockwise rotation along the rotation axis RA, and the rotation time is 1 to 5 seconds, but the present disclosure is not limited thereto. In other aspects, the fifth action A5 may be, for example, a counterclockwise rotation along the rotation axis RA, with a rotation time of 1 to 5 seconds, and the sixth action A6 may be, for example, a clockwise rotation along the rotation axis RA, with a rotation time of 1 to 5 seconds. In one embodiment of the present disclosure, the rotation directions of the fifth action A5 and the sixth action A6 are different. In the present disclosure, there is no particular limit to the number of clockwise and/or counterclockwise rotations, as long as the action is completed within a specific time. In one embodiment of the present disclosure, the shaking device 300 can perform a shaking operation for 1500 to 2500 cycles, and the shaking operation may include the fifth action A5 and the sixth action A6 as described above. When the shaking operation meets the above definition, the dissolution efficiency of the solute in the container 23 can be improved, thereby achieving the effect of shortening the dissolution time.

In another embodiment of the present disclosure, as shown in FIG. 6B and FIG. 8, when the driving element 33 drives the spindle 32, the engagement unit 31 may rotate in a seventh motion A7, an eighth motion A8 following the seventh motion A7, and a ninth motion A9 following the eighth motion A8. The seventh motion A7 is, for example, a clockwise rotation of 90 to 150 degrees along the rotation axis RA (that is, 90°≤the angle≤150°), the eighth motion A8 is, for example, a counterclockwise rotation of 270 to 300 degrees along the rotation axis RA (that is, 270°≤the angle≤300°), and the ninth motion A9 is, for example, restoring the shaking device 300 to the initial position, that is, restoring the extension direction ED of the body 311 to be parallel to the horizontal plane (for example, the XZ plane) and perpendicular to the rotation axis RA. When the rotation angle of the above action meets the above definition, the dissolution efficiency of the solute in the container 23 can be improved. The “angle” may be as described in the above definition and will not be described again here. In one embodiment of the present disclosure, the rotation directions of the seventh motion A7 and the eighth motion A8 are different, and the rotation angles of the seventh motion A7 and the eighth motion A8 are different. In one embodiment of the present disclosure, the shaking device 300 can perform a shaking operation for 4000 to 7000 cycles, and the shaking operation may include the seventh motion A7, the eighth motion A8 and the ninth motion A9 as described above. When the shaking operation meets the above definition, the dissolution efficiency of the solute in the container 23 can be improved, thereby achieving the effect of shortening the dissolution time.

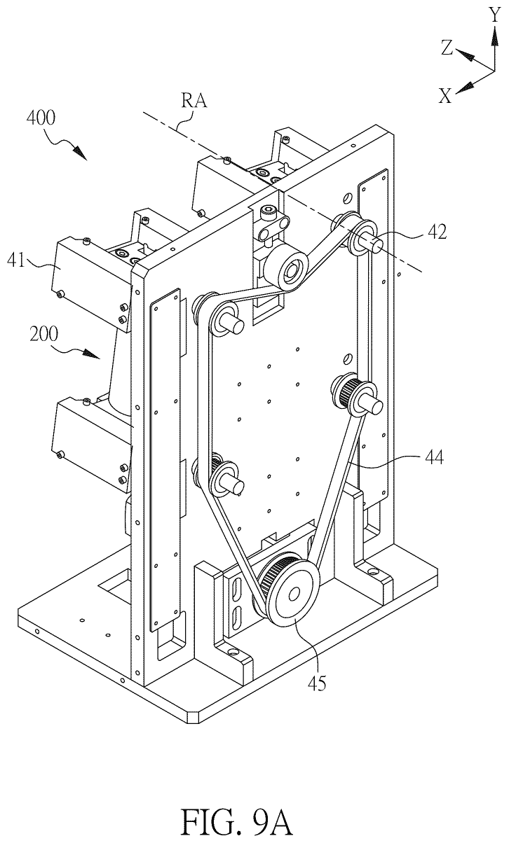

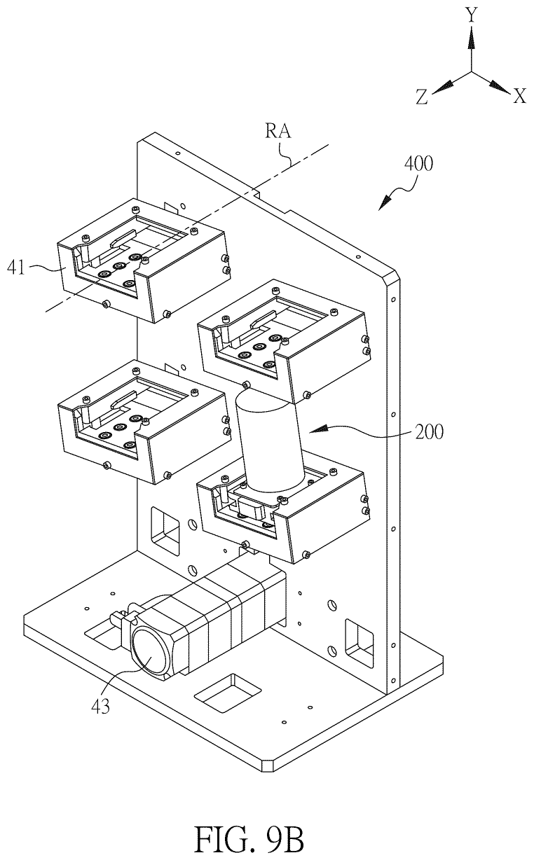

FIG. 9A and FIG. 9B are schematic three-dimensional diagrams of a shaking device according to one embodiment of the present disclosure.

In one embodiment of the present disclosure, as shown in FIG. 9A and FIG. 9B, the shaking device 400 may be used to place a container assembly 200, and the shaking device 400 may comprise at least one engagement unit 41; a spindle 42, wherein the at least one engagement unit 41 is fixed on the spindle 42; and a driving element 43 coupled with the spindle 42, wherein the driving element 43 drives the spindle 42 to drive the at least one engagement unit 41 to rotate or swing. In the present disclosure, the container assembly 200 may be as shown in FIG. 3, and the detailed structure of the engagement unit 41 may be as shown in the engagement unit 31 of FIG. 6A to FIG. 6D, which will not be described in detail herein. In one embodiment of the present disclosure, as shown in FIG. 9A and FIG. 9B, the shaking device 400 includes four engagement units 41, and the four engagement units 41 are arranged in a 2×2 array as an example, but the present disclosure is not limited thereto. In other aspects, the number and location of the engagement units 41 can be adjusted as needed.

In one embodiment of the present disclosure, as shown in FIG. 9A and FIG. 9B, the shaking device 400 may further comprise a timing belt 44 and a timing wheel 45, wherein the driving element 43 drives the timing wheel 45 and the timing belt 44 to rotate in engagement, thereby driving the spindle 42 to drive the engagement unit 41 to rotate along a rotation axis RA. The extension direction of the rotation axis RA may be parallel to a horizontal plane (for example, the XZ plane). In one embodiment of the present disclosure, as shown in FIG. 9A and FIG. 9B, the rotation axis RA may be, for example, parallel to the extension direction of the spindle 42 (that is, may be, for example, parallel to the Z direction), but the present disclosure is not limited thereto. In the present disclosure, the “rotation axis RA” refers to, for example, a virtual line around which the spindle 42 rotates.

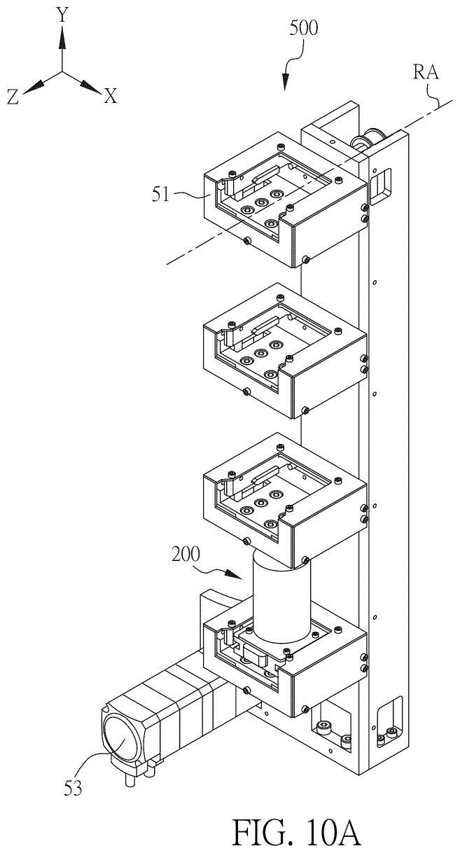

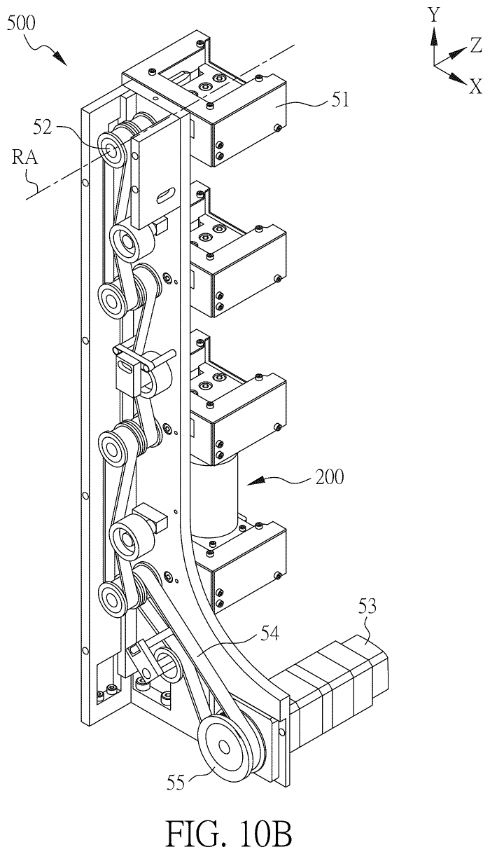

FIG. 10A and FIG. 10B are schematic three-dimensional diagrams of a shaking device according to one embodiment of the present disclosure.

In one embodiment of the present disclosure, as shown in FIG. 10A and FIG. 10B, the shaking device 500 may be used to place a container assembly 200, and the shaking device 500 may comprise at least one engagement unit 51; a spindle 52, wherein the at least one engagement unit 51 is fixed on the spindle 52; and a driving element 53 coupled with the spindle 52, wherein the driving element 53 drives the spindle 52 to drive the at least one engagement unit 51 to rotate or swing. In the present disclosure, the container assembly 200 may be as shown in FIG. 3, and the detailed structure of the engagement unit 51 may be as shown in the engagement unit 31 of FIG. 6A to FIG. 6D, which will not be described in detail herein. In one embodiment of the present disclosure, as shown in FIG. 10A and FIG. 10B, the shaking device 500 includes four engagement units 51, and the four engagement units 51 are arranged in a 1×4 array as an example, but the present disclosure is not limited thereto. In other aspects, the number and location of the engagement units 51 can be adjusted as needed.

In one embodiment of the present disclosure, as shown in FIG. 10A and FIG. 10B, the shaking device 500 may further include a timing belt 54 and a timing wheel 55. The driving element 53 drives the timing wheel 55 and the timing belt 54 to rotate in engagement, thereby driving the spindle 52 to drive the engagement unit 51 to rotate along a rotation axis RA. The rotation axis RA may be parallel to a horizontal plane (for example, the XZ plane). In one embodiment of the present disclosure, as shown in FIG. 10A and FIG. 10B, the rotation axis RA may be, for example, parallel to the extension direction of the spindle 52 (that is, may be, for example, parallel to the Z direction), but the present disclosure is not limited thereto. In the present disclosure, the “rotation axis RA” refers to, for example, a virtual line around which the spindle 52 rotates.

The present disclosure can improve the dissolution efficiency of the solute by using a specially designed shaking device and a shaking operation. In addition, the burden on medical staff can be reduced by realizing automated operations.

The above specific embodiments should be construed as merely illustrative, and not limiting of the remainder of the disclosure in any way.

Although the present disclosure has been explained in relation to its embodiment, it is to be understood that many other possible modifications and variations can be made without departing from the spirit and scope of the disclosure as hereinafter claimed.

1. A shaking device used for placing a container assembly and comprising:
at least one engagement unit comprising:
a body; and
a latching element disposed on the body, wherein the at least one engagement unit engages with the container assembly through the latching element;
a spindle, wherein the at least one engagement unit is fixed on the spindle; and
a driving element coupled with the spindle,
wherein the driving element drives the spindle to drive the at least one engagement unit to rotate or swing.

2. The shaking device of claim 1, wherein the at least one engagement unit rotates along a rotation axis, and the rotation axis is parallel to a horizontal plane.

3. The shaking device of claim 1, wherein the at least one engagement unit further comprises a protruding part disposed on the body, and the protruding part and the container assembly interfere with each other when the container assembly is placed on the shaking device.

4. The shaking device of claim 3, wherein the at least one engagement unit further comprises:
a base plate, wherein the body is fixed on the base plate;
a moving element disposed on the base plate; and
an elastic element disposed between the base plate and the moving element.

5. The shaking device of claim 4, wherein a length of the elastic element is less than an initial length when the container assembly is placed on the shaking device.

6. The shaking device of claim 4, wherein the protruding part of the at least one engagement unit contacts a groove of the container assembly when the container assembly is place on the shaking device.

7. The shaking device of claim 6, wherein the container assembly comprises:
a base;
a fastening part disposed on the base, wherein the engagement unit engages with the fastening part of the container assembly through the latching element; and
a container fixed on the base.

8. The shaking device of claim 7, wherein the base of the container assembly further comprises the groove.

9. The shaking device of claim 4, wherein one end of the spindle is connected to the base plate.

10. The shaking device of claim 9, wherein the other end of the spindle is engaged with a bevel gear set, and the spindle is coupled to the driving element through the bevel gear set.

11. The shaking device of claim 10, wherein the spindle is coupled to the driving element through the bevel gear set and a transmission shaft.

12. The shaking device of claim 1, wherein the at least one engagement unit rotates in a single first motion.

13. The shaking device of claim 1, wherein the at least one engagement unit rotates with a first motion and a second motion following the first motion.

14. The shaking device of claim 13, wherein the at least one engagement unit rotates by a first angle in the first motion, and the first angle is 10 to 30 degrees.

15. The shaking device of claim 13, wherein the at least one engagement unit rotates by a second angle in the second motion, and the second angle is 10 to 30 degrees.

16. The shaking device of claim 13, wherein rotation directions of the first motion and the second motion are the same, and rotation angles of the first motion and the second motion are different.

17. The shaking device of claim 13, wherein rotation directions of the first motion and the second motion are different.

18. The shaking device of claim 17, wherein rotation angles of the first motion and the second motion are different.

19. The shaking device of claim 1, further comprising: a timing belt and a timing wheel, wherein the driving element drives the timing wheel and the timing belt to drive the spindle to drive the engagement unit to rotate along a rotation axis.

20. The shaking device of claim 19, wherein the rotation axis is parallel to a horizontal plane.
